(19) United States
(12) Patent Application Publication
(10) Pub. No.: US 2008/0141574 A1
(43) Pub. Date: Jun. 19, 2008

(54) Color-coded identification plug

(76) Inventor: Dustin Paul Jones, Hercher, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/002,257

(22) Filed: Dec. 14, 2007

Related U.S. Application Data
(60) Provisional application No. 60/870,352, filed on Dec. 15, 2006.

(51) Int. Cl. G09F 3/18

(52) U.S. Cl. 40/660

(57) ABSTRACT

A color-coded identification plug facilitates identification of pipes, conduits, and like structures at a construction or building site. The identification plug is preferably of unitary or one-piece construction, including a generally elongated shaft portion, and a generally planar handle portion joined to one end of the shaft portion to facilitate manipulation of the plug. The plug includes at least one, and preferably a plurality of resiliently deformable rings extending radially outwardly from the shaft portion, in spaced relationship to the handle portion. The rings are preferably formed with increasing diameters, in a direction away from the handle portion to facilitate insertion within variously sized pipes or conduits, with at least one of the rings fitting exteriorly of the pipe conduit to limit insertion of the plug into the pipe, and prevent debris or the like from entering the pipe.

### CROSS-REFERENCE TO RELATED APPLICATION

This application claims the benefit of U.S. Provisional Patent Application Ser. No. 60/870,352, filed Dec. 15, 2006.

### TECHNICAL FIELD

The present invention relates generally to devices for facilitating identification of pipes or like cylindrical structures, such as a construction or building site, and more particularly to an identification plug which can be removably inserted in the pipe to facilitate its identification, which plug can be color-coded, and/or provided with written indicia to facilitate identification.

### BACKGROUND OF THE INVENTION

In conjunction with the construction industry, it is typically necessary for various pipes, conduits, and like structures, typically cylindrical, to be properly identified in connection with typical construction, such as for installation of electrical and plumbing systems. Given the great multiplicity of such pipes and conduits which can be found in a typical construction site, it is highly desirable that proper identification of the various pipes and conduits be facilitated to promote efficiency in the construction project.

The present invention is directed to a desirably straightforward device which can be conveniently used to identify pipes, conduits, and like cylindrical structures in a building and construction site, thereby desirably promoting efficiency in the construction, while avoiding undesirable misidentification of such construction components.

### SUMMARY OF THE INVENTION

In accordance with the present invention, an identification plug is provided which can be economically manufactured, and easily used for identification of pipes, conduits, and like cylindrical structures in a construction or building site. The identification plug can be conveniently inserted and removed from an associated pipe or like structure, and can be color-coded to further facilitate identification of the various pipes and conduits found at the construction site. In the preferred form, the identification plug can be configured to bear written indicia, and may be configured to facilitate securement of a tag or like element for further bearing written indicia, including identification information and the like.

In accordance with the illustrated embodiment, the present identification plug comprises a generally elongated shaft portion, and a generally planar handle portion joined to one end of the shaft portion. The handle portion facilitates manipulation of the plug, so that the plug can be readily grasped for insertion into, and removal from, an associated pipe or like cylinder structure.

The identification plug includes at least one resiliently deformable ring extending radially outwardly from the shaft portion, in spaced relationship to the handle portion. In the preferred form, the plug includes a plurality of deformable rings extending radially outwardly from the shaft portion in axially spaced relation to each other. The various rings are preferably sized in different diameters, with the rings being of increasing diameters in a direction away from the handle portion. By this configuration, one of the rings can be sized to fit exteriorly of the pipe, while another one of the rings, spaced further from the handle portion, is sized to fit within and engage the interior of the pipe.

Other features and advantages of the present invention will become readily apparent from the following detailed description, the accompanying drawings, and the appended claims.

### BRIEF DESCRIPTION OF THE DRAWINGS

FIG. 1 is a diagrammatic view of the identification tag of the present invention illustrated in operative association with a pipe, such as at a building or construction site;

FIG. 2 is a side elevational view of the identification tag shown in FIG. 1;

FIG. 3 is a sectional view taken at “A” of FIG. 2; and

FIG. 4 is a bottom plan view of the identification plug shown in FIG. 2.

### DETAILED DESCRIPTION

While the present invention is susceptible of embodiment in various forms, there is shown in the drawings and will hereinafter be described a presently preferred embodiment, with the understanding that the present disclosure is to be considered as an exemplification of the invention, and is not intended to limit the invention to the specific embodiment illustrated.

With reference to the FIGURES, therein is illustrated an identification plug 10 embodying the principles of the present invention. Identification plug 10 is configured to be removably inserted in a pipe, conduit, or like structure, as typically found in a construction or building site. By this arrangement, workers at the site can conveniently identify any of the great multiplicity of pipes and conduits typically found at the cite, with the present invention contemplating that the present identification plug can be color-coded, such that differently colored ones of the plugs can be used to identify the different types of pipes or conduits typically found at the construction site.

In accordance with the illustrated embodiment, the identification plug 10 is preferably of a unitary or one-piece construction, and includes a generally elongated shaft portion 12, and a generally planar portion 14 joined to one end of the shaft portion. The handle portion 14 facilitates manipulation of the plug, in that the plug can be readily grasped for insertion into, and removal from, and associated pipe or like structure. As illustrated in FIG. 4, the shaft portion 12 of the identification plug has a generally X-shaped cross-section.

To facilitate insertion into, and removable retention from within an associated pipe, identification plug 10 includes at least one, and preferably a plurality of resiliently deformable rings extending radially outwardly from the shaft portion 12, in spaced relationship to the handle portion 14. In the illustrated embodiment, the identification tag includes three of the radially extending rings, 16, 18, and 20, with the rings preferably being of increasing diameters in a direction away from the handle portion 14.

As will be appreciated, the deformable rings of the identification plug can be conveniently sized for cooperative engagement with standard sizes of pipes and conduits typically found at a construction site. As such, the present identification plug can be configured such that one of the rings fits exteriorly of the associated pipe, while another one of the rings, spaced further from the handle portion 14, is sized to fit within and engage the interior of the pipe to create an interference seal. By this arrangement, the plug is desirably removably held in position with the pipe, while one of the rings acts to generally close the end of the pipe, preventing debris or the like from entering into the pipe.

As illustrated, the generally planar handle portion 14 of the identification plug 10 desirably provides a surface upon which identification indicia or the like can be provided, either by embossment on the handle portion, and/or written application of indicia. Additionally, the handle portion 14 can be provided with a suitable opening 22 to facilitate securement of an associated element, such as a further identification tag, or like element bearing identification or other information.

As noted, color-coding of the present identification tag facilitates its efficient use, permitting convenient and efficient visual identification of various pipes and conduits by workers at a construction site. By way of example, the following color coding can be employed:

| | |
|---|---|
| yellow | regular lighting |
| blue | emergency lighting |
| green | regular power |
| orange | computer power |
| red | fire alarm |
| purple | other |

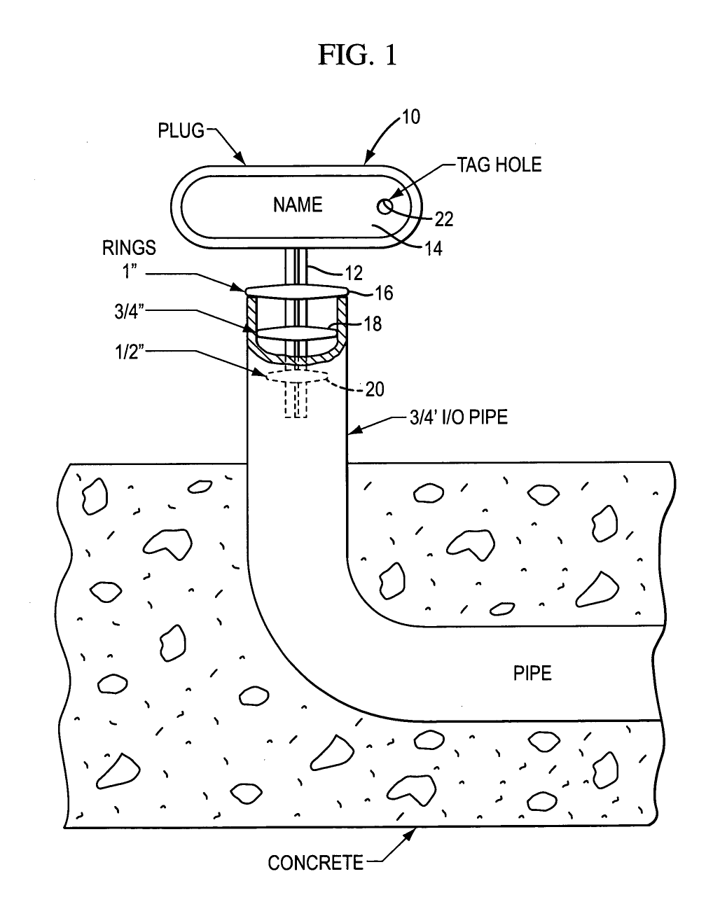

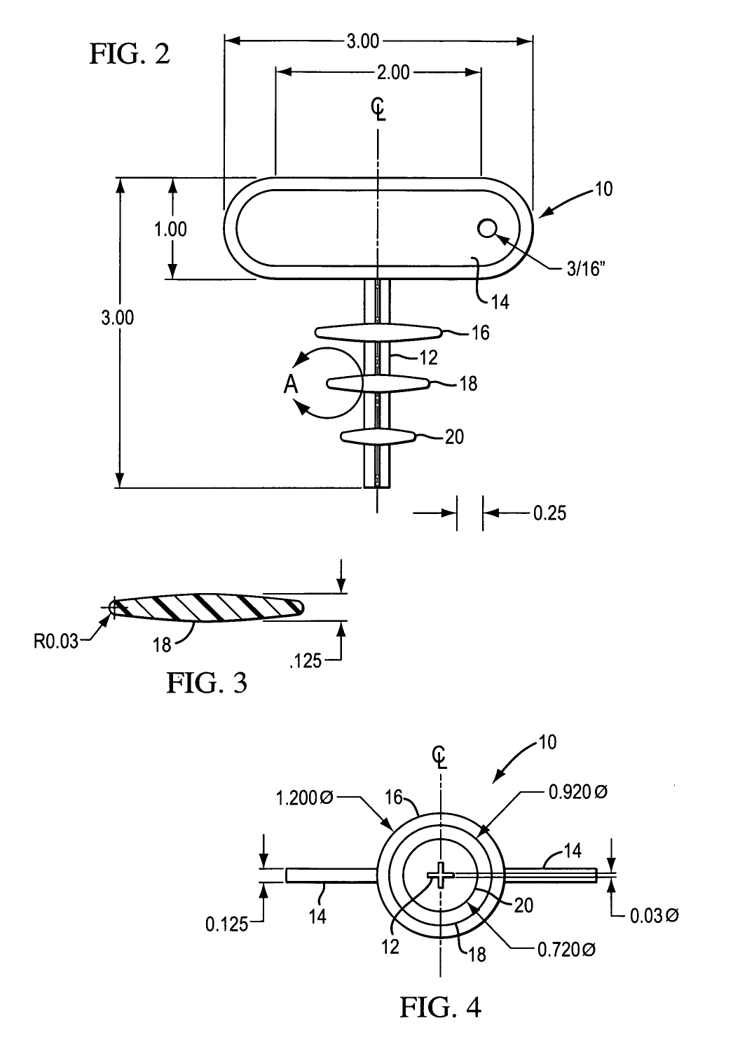

As will be appreciated from FIG. 1, wherein the present identification tag is illustrated in operative association with a pipe positioned in concrete, the plug 10 can desirably function to prevent concrete from entering the pipe, but facilitates efficient identification of various pipes and conduits which may extend from the concrete. Circuit numbers or the like can be readily provided on various plugs to facilitate wire pulls. The present plug can be used in a pipe in the inside of block or brick walls to keep the brick's mud out of the pipe, with positioning of plugs in respective pipes that hook out of the wall facilitating tie-ins with the associated rooms. Again, it will be appreciated that the present invention desirably minimizes the man-hours required by workers having to go back to associated prints or like plans for the structure to identify pipes, conduits, and like construction components.

Is should be appreciated that the present identification plug can be configured to fit differently shaped openings, such as by configuring the deformable rings of the plug to have configurations other than circular. As noted, a single one of the present identification plugs can be made to fit more than one size opening. Thus, the present identification plug can be used to plug and identify any opening in a pipe or like cylindrical structure, whatever the shape of the opening, and can also be used in any tubing shaped product as an identifier for shipping or storage.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. An identification plug, comprising:
a generally elongated shaft portion:
a generally planar handle portion joined to one end of said shaft portion, said handle portion facilitating manipulation of said plug; and
at least one relisiently deformable ring extending radially outwardly from said shaft portion, in spaced relationship to said handle portion,
whereby said plug is insertable in a pipe or like structure to facilitate identification of said pipe.

2. An identification plug in accordance with claim 1, wherein:
said plug includes a plurality of said deformable rings extending radially outwardly from said shaft portion in axially spaced relationship to each other, said rings being of increasing diameters in a direction away from said handle portion.

3. An identification plug in accordance with claim 1, wherein:
said identification plug is color-coded.

4. An identification plug in accordance with claim 1, wherein:
said handle portion defines an opening to facilitate securement of an associated element to said plug.

5. An identification plug in accordance with claim 2, wherein:
one of said rings is sized to fit exteriorly of said pipe to limit insertion of the plug, while another one of said rings, spaced further from said handle portion, is sized to fit within and engage the interior of said pipe.

6. An identification plug in accordance with claim 1, wherein:
said shaft portion has a generally x-shaped cross-section.

7. An identification plug in accordance with claim 1, wherein:
said deformable ring is circular.
